(19) United States
(12) Patent Application Publication
(10) Pub. No.: US 2026/0126287 A1
(43) Pub. Date: May 7, 2026

(54) MULTI-PROJECTOR 3D SCANNING SYSTEM AND METHOD FOR PERFORMING SAME

(71) Applicant: POLYRIX INC., Saint-Augustin-de-Desmaures (CA)

(72) Inventors: Philippe LAMBERT, Saint-Augustin-de-Desmaures (CA); Jean-Daniel DESCHENES, Saint-Augustin-de-Desmaures (CA)

(21) Appl. No.: 19/481,487

(22) PCT Filed: May 3, 2024
(86) PCT No.: PCT/CA2024/050610

§ 371 Date: Nov. 4, 2025

Related U.S. Application Data
(60) Provisional application No. 63/500,434, filed on May 5, 2023.

(51) Int. Cl. G01C 11/02; G01B 11/245; G01B 11/25; G01C 11/30; G01C 11/36

(52) U.S. Cl. CPC G01C 11/025; G01B 11/245; G01B 11/2513; G01C 11/30; G01C 11/36; G01B 2210/60

(57) ABSTRACT

A system for performing 3D scanning of an object using multiple projectors projecting a grid of source light signals on surface points of the object, with at least two of the projectors projecting overlapping source light signals; multiple cameras capturing images defining a grid of corresponding light intensities on the outer surface of the object varying over time to define a received light signal for each surface point; and a computing device controlling each one of the projectors such that each source signal of the grid of source light signals projected therefrom has a unique signal characteristics allowing a subsequent demultiplexing of received light signals for surface points where the source light signals of at least two overlapping projectors are combined, and perform signal processing on each received light signal to isolate therefrom constituent source light signals having the unique signal characteristic associated to a corresponding one of the projectors

### CROSS-REFERENCE TO RELATED APPLICATIONS

This application is a National Stage of International Application No. PCT/CA2024/050610, having an International Filing Date of 3 May 2024, which designated the United States of America, and which International Application was published under PCT Article 21(2) as WO Publication No. 2024/175725 which claims priority under 35 USC § 119(e) of U.S. provisional patent application 63/500,434, filed on May 5, 2023, the disclosures of which are hereby incorporated by reference in their entireties.

### TECHNICAL FIELD OF THE INVENTION

The present invention relates to the field of object inspection. More particularly, it relates to a system for performing 3D scanning of an object using multiple fixed cameras and projectors and to a method for performing 3D scanning of an object using multiple fixed cameras and projectors.

### BACKGROUND

Several systems and corresponding methods of operation are known in the art to perform 3D scanning of an object.

For example, it is known to use structured-light 3D scanner projecting light patterns onto the surface of the object using a projector and a corresponding camera to triangulate the position of surface points of the object.

However, the current state of the art in 3D structured light scanning requires that only one projector beam its series of light patterns at a time. Otherwise, if multiple projectors beam series of light patterns at the same time, the projected patterns may interfere on the object and the triangulation is no longer possible. Such a drawback greatly limits the speed at which scanning of an entire 3D object can be performed, as the time required to perform the scan of the object is directly proportional to the time required for beaming the series of light patterns by each one of the projectors required for covering the entire 3D object and acquiring the light data by the associated cameras.

One skilled in the art would understand that when the projected light from two projectors do not significantly overlap on the object (for instance if they are far apart or opposite from one another), it is possible to use the two non-overlapping projectors simultaneously to reduce the scanning time. However, in most cases, this is not possible as there is often significant overlap between the light patterns projected by the projectors, which are consequently required to wait on one another to perform sequential beaming (one after the other), with the cameras acquiring the light data of the sequential beaming.

In view of the above, there is a need for an improved system for performing 3D scanning of an object using multiple fixed cameras and projectors and to a method for performing 3D scanning of an object using multiple fixed cameras and projectors, which, by virtue of its design and/or components, would be able to overcome or at least minimize some of the above-discussed prior art concerns.

### SUMMARY

In accordance with a first general aspect, there is provided a system for performing 3D scanning of an object having an outer surface defined by surface points. the system comprises: multiple fixed projectors each projecting a grid of source light signals on the outer surface of the object, with at least two of the projectors projecting source light signals overlapping on surface points of the outer surface of the object when the projectors project the source light signals simultaneously; multiple fixed cameras capturing images defining a grid of corresponding light intensities on the outer surface of the object, with the grid of light intensities of successive images varying over time defining a received light signal for each surface point of the outer surface of the object; and a computing device in data communication with the multiple fixed projectors and the multiple fixed cameras, the computing device being configured to control the multiple fixed projectors such that each source signal of the grid of source light signals projected therefrom is associated to a corresponding source point of a corresponding one of the projectors and has a unique signal characteristics associated to the corresponding one of the projectors allowing a subsequent demultiplexing of received light signals for surface points of the outer surface of the object where the source light signals of the at least two of the projectors projecting source light signals overlapping on surface points of the outer surface of the object are combined, and the computing device being further configured to collect received light signals for each surface point of the outer surface of the object and performing signal processing on the received light signals in order to demultiplex the received light signals and isolate therefrom constituent source light signals having the unique signal characteristic associated to the corresponding one of the projectors.

In an embodiment, the computing device is configured to control the projectors such that each one of the projectors projects the grid of source light signals, with each source light signals thereof having a specific carrying frequency associated to the corresponding one of the multiple fixed projectors and being unique to the corresponding one of the projectors.

In an embodiment, the computing device is configured to control the projectors such that each one of the projectors projects the grid of source light signals, with each source light signals thereof having a phase associated to the specific source point of the corresponding one of the projectors.

In an embodiment, in a first projection the phase is indicative of the column of the source point of the corresponding one of the projectors and in a second projection the phase is indicative of the line of the source point of the corresponding one of the projectors.

In an embodiment, the computing device is further configured to determine from each one of the constituent source light signals the corresponding projector and the corresponding source point thereof.

In an embodiment, the computing device is further configured to determine the spatial coordinates of each surface points by triangulation, using constituent source light signals, the position of the source points of each corresponding one of the projectors and the position of the cameras.

In an embodiment, the object has a known geometry and, prior to scanning, the computing device is configured to identify projectors projecting overlapping source light signals towards specific surface points of the outer surface of at least one outer surface section of the object having the known geometry and to generate and apply operative masks for the identified projectors in order to limit the number of projectors projecting source light signals towards the specific surface points of the outer surface section.

In an embodiment, the computing device is configured to generate and apply operative masks for every identified outer surface section of the outer surface of the object where projectors will project overlapping source light signals towards surface points of the outer surface of the object when projecting source light signals simultaneously.

In an embodiment, the computing device is configured to generate the operative masks by determining which subset of the projectors identified as having source points projecting overlapping source light signals towards surface points of the outer surface of the object in each one of the at least one outer surface section is most likely to provide the best light signal at the outer surface section and masking the other projectors for the projectors other than those of the subset of projectors identified as most likely to provide the best light signal at the outer surface section not to project any source light signal directed towards the outer surface section during scanning of the object.

In an embodiment, prior to scanning, the computing device is configured to identify projectors projecting source light signals towards surface points of the outer surface of at least one section of the object having an intensity imbalance sufficient to create crosstalk and/or light bleed and to generate and apply intensity masks for the identified projectors in order to balance the intensity of the source light signals.

In accordance with another general aspect, there is also provided a method for performing multi-projector 3D scanning. The method comprises: controlling multiple fixed projectors of a multi-projector scanning system by a computing device for each one of the projectors to project a grid of source light signals towards the outer surface of an object to be scanned, with each source signal of the grid of source light signals being associated to a corresponding source point of the corresponding one of the multiple projectors and having a unique signal characteristics associated to the corresponding projector allowing signal demultiplexing of each received light signals in which the source light signals of at least two projectors projecting source light signals overlapping on surface points of the outer surface of the object are combined; projecting the grid of source light signals from each one of the multiple projectors simultaneously on the outer surface of the object to be scanned; capturing images defining a grid of corresponding light intensities on the outer surface of the object using cameras, with the light intensities of successive image varying over time defining the received light signal for each surface point of the outer surface of the object; performing signal processing on each received light signal by the computing device in order to demultiplex the received light signals and isolate therefrom constituent source light signals having the unique signal characteristic associated to a corresponding one of the projectors and determine from the associated source light signal the corresponding projector and the corresponding source point thereof; and determining by the computing device the spatial coordinates of each surface points by triangulation.

In an embodiment, the method further comprises determining, by the computing device, a signal frequency associated to each one of the multiple fixed projectors and controlling each one of the projectors by the computing device, for each source signal of the grid of source light signals thereof to have a carrying frequency corresponding to the signal frequency associated to the corresponding one of the projectors.

In an embodiment, the method further comprises controlling each one of the projectors by the computing device for each source light signals of the grid of source light signals thereof to have a phase associated to the specific source point of the corresponding one of the projectors.

In an embodiment, in a first projection the phase is indicative of the column of the source point of the corresponding one of the projectors and in a second projection the phase is indicative of the line of the source point of the corresponding one of the projectors.

In an embodiment, the object has a known geometry and the method further comprises: prior to the step of projecting the grid of source light signals from each one of the multiple projectors simultaneously on the outer surface of the object, identifying, by the computing device, projectors projecting overlapping source light signals towards specific surface points of the outer surface of at least one outer surface section of the object having the known geometry; and generating and applying operative masks for the identified projectors in order to limit the number of projectors projecting source light signals towards the specific surface points of the outer surface section.

In an embodiment, the method further comprises generating and applying operative masks for every identified outer surface section of the outer surface of the object where projectors will project overlapping source light signals towards surface points of the outer surface of the object when projecting source light signals simultaneously.

In an embodiment, the step of generating and applying operative masks includes determining, by the computing device, which subset of the projectors identified as having source points projecting overlapping source light signals towards surface points of the outer surface of the object in each one of the at least one outer surface section is most likely to provide the best light signal at the outer surface section and masking the other projectors for the projectors other than those of the subset of projectors identified as most likely to provide the best light signal at the outer surface section not to project any source light signal directed towards the outer surface section during scanning of the object.

In an embodiment, the method further comprises: prior to the step of projecting the grid of source light signals from each one of the multiple projectors simultaneously on the outer surface of the object, identifying projectors projecting source light signals towards surface points of the outer surface of at least one section of the object having an intensity imbalance sufficient to create crosstalk and/or light bleed; and generating and applying intensity masks for the identified projectors in order to balance the intensity of the source light signals.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a schematic representation of the components of the system performing multi-projector 3D scanning.

FIG. 2 is an image presenting the components of the system of FIG. 1.

FIG. 3 is a diagram showing the step of the method for performing multi-projector 3D scanning.

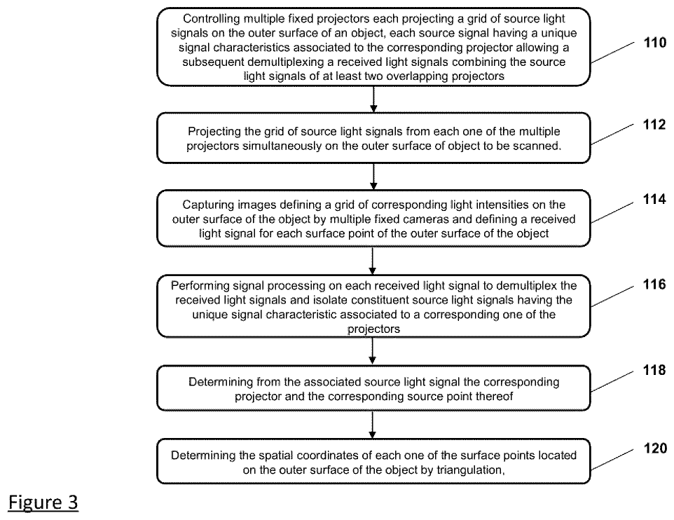

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the system for performing 3D scanning and corresponding parts thereof consist of certain configurations as explained and illustrated herein, not all of these configurations are essential and thus should not be taken in their restrictive sense. It is to be understood, as also apparent to a person skilled in the art, that other suitable components and cooperation thereinbetween, as well as other suitable configurations, may be used for the system for performing 3D scanning, as will be briefly explained herein and as can be easily inferred herefrom by a person skilled in the art. Moreover, it will be appreciated that positional descriptions such as “above”, “below”, “left”, “right”, “up”, “down” and the like should, unless otherwise indicated, be taken in the context of the figures and should not be considered limiting.

Moreover, although the associated method includes steps as explained and illustrated herein, not all of these steps are essential and thus should not be taken in their restrictive sense. It will be appreciated that the steps of the method for performing 3D scanning described herein may be performed in the described order, or in any suitable order. In an embodiment, steps of the proposed method are implemented as software instructions and algorithms, stored in computer memory and executed by processors. It should be understood that servers and computers are therefore required to implement the proposed system, and to execute the proposed method. In other words, the skilled reader will readily recognize that steps of the method can be performed by programmed computers. In view of the above, some embodiments are also intended to cover program storage devices, e.g., digital data storage media, which are machine or computer readable and encode machine-executable or computer-executable programs of instructions, wherein said instructions perform some or all of the steps of said above-described methods. The embodiments are also intended to cover computers programmed to perform said steps of the above-described methods.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

The term “computing device” is used to encompass computers, servers and/or specialized electronic devices which receive, process and/or transmit data. “Computing devices” are generally part of “systems” and include processing means, such as microcontrollers and/or microprocessors, CPUs or are implemented on FPGAs, as examples only. The processing means are used in combination with storage medium, also referred to as “memory” or “storage means”. Storage medium can store instructions, algorithms, rules and/or data to be processed. Storage medium encompasses volatile or non-volatile/persistent memory, such as registers, cache, RAM, flash memory, ROM, as examples only. The type of memory is of course chosen according to the desired use, whether it should retain instructions, or temporarily store, retain or update data.

One skilled in the art will therefore understand that each such computing device typically includes a processor (or multiple processors) that executes program instructions stored in the memory or other non-transitory computer-readable storage medium or device (e.g., solid state storage devices, disk drives, etc.). The various functions, modules, services, units or the like disclosed hereinbelow can be embodied in such program instructions, and/or can be implemented in application-specific circuitry (e.g., ASICs or FPGAs) of the computing devices. Where a computer system includes multiple computing devices, these devices can, but need not, be co-located. In some embodiments, a computer system can be a cloud-based computing system whose processing resources are shared by multiple distinct business entities or other users. Interface and network cards can be installed in the computing device to allow the connection with other computers of a computer network and/or to the cameras and/or projectors of the system. In an embodiment, the computing device can be associated to a user interface allowing, visualisation of inspection data generated by the system as well as allowing the user to operate the system, for example and without being limitative, to start the inspection process, using peripherals such as mouse, keyboards or the like.

It should be appreciated by those skilled in the art that any block diagrams herein represents conceptual views of illustrative circuitry embodying the principles disclosed herein. Similarly, it will be appreciated that any flow charts and transmission diagrams, and the like, represent various processes which may be substantially represented in computer readable medium and so executed by a computer or processor, whether or not such computer or processor is explicitly shown.

The terms “a”, “an” and “one” are defined herein to mean “at least one”, that is, these terms do not exclude a plural number of items, unless stated otherwise.

In the course of the present document, the term “object” is used to refer to any article, part or assembly inspected using the inspection system or method described herein and having an outer surface defined by a plurality of surface points with specific spatial coordinates which together define the shape of the object. It will be readily understood that the object being inspected need not be a complete article, part or assembly, but can be embodied by a section or portion, of a corresponding article, part or assembly.

In the course of the present document, the expression “scanning data” is used to refer to data acquired concerning a 3D object, during inspection of an outer surface thereof and which allows determination of the spatial coordinates of points on the outer surface of the object in order to generate a 3D model of the object.

Moreover, in the course of the present document, the term “light projector” is used to refer to devices operative to project light on a surface, such as the outer surface of a 3D object. As will be described in more details below, the light projector can be controlled such as to regulate the characteristics (i.e. color, intensity, shade, etc.) of the light projected by each source point thereof. Indeed, light projectors each define a plurality of source points. For example, in an embodiment, the light projectors can include an array of pixels, and each one of the plurality of source points can correspond to a specific pixel of the an array of pixels of a corresponding light projector. One skilled in the art will understand that, in an alternative embodiment, the source points can also correspond to a group of pixels of a light projector. In an embodiment, the at least one light projector 30 is a video projector, such as off-the-shelf DLP, LCD or CRT video-projector like the BenQ W1000+™, Optoma ZH403™, or the like, or any custom-made light projector. One skilled in the art will understand that, in the system and method described below, where a plurality of light projectors are present, the light projectors can be all of a same type and/or model, or alternatively different types and/or models of projectors can be used.

In the course of the present document, the term “camera” is used to refer to devices operative to capture, store and transfer images. The camera can be a video or a still camera, including industrial cameras from manufacturers such as PointGrey™, Allied Vision Technologies™ or the like, or any commercially available cameras from manufacturers such as Canon™, Sony™, or the like. As with the light projector, one skilled in the art will understand that the plurality of cameras being used in the system and method described below can be all of a same type and/or model, or alternatively different types and/or models of cameras can be used.

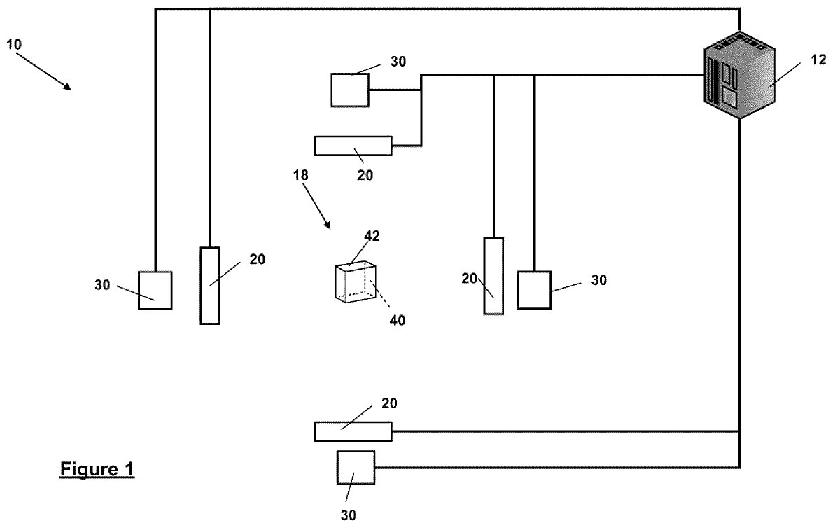

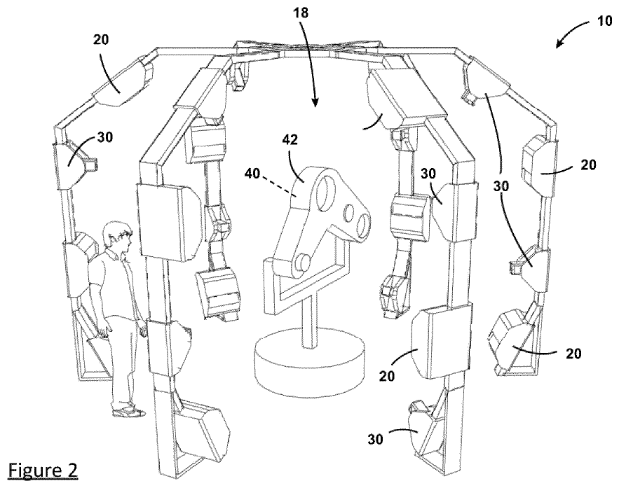

With reference to FIGS. 1 and 2, the system 10 for performing 3D scanning will be described in more details below. The system 10 includes multiple fixed projectors 20 and multiple fixed cameras 30 each having a field of view. The field of views of the multiple fixed projectors 20 can intersect with one another, such that multiple projectors can project light on at least a same portion of the outer surface of an object 40 located in an inspection section 18 of the system 10, when the projectors 20 operate simultaneously. One skilled in the art will understand that the positioning and quantity of multiple fixed projectors 20 and multiple fixed cameras 30 can be varied in accordance with different embodiments.

The combination of the field of views of the multiple fixed projectors 20 and the multiple fixed cameras 30 jointly define a field of view of the system 10 (i.e. the area where light can both be projected on surface points defining the outer surface of an object 40 by the projectors 20 and be captured by the cameras 30). In an embodiment the field of view of the system 10 can cover substantially a 4pi steradians area in order to allow 3D scanning of all surface points of the object 40 provided in the inspection section 18 of the system 10. One skilled in the art will understand that in alternative embodiments, the field of view of the system 10 could cover a different range in order to allow 3D scanning of specific sections of an object 40 provided in the inspection section 18 of the system 10.

The multiple fixed projectors 20 and corresponding multiple fixed cameras 30 are in data communication with a computing device 12 configured to control the operation of the projectors 20 and receive the scanning data from the cameras 30, in order to determine the spatial coordinates of the surface points of the outer surface of the object 40 by triangulation and generate a 3D model of the object representing the outer surface 42 of the scanned object 40.

In an embodiment, the projectors 20, cameras 30 and the computing device 12 operate such that the system 10 is a structured light 3D scanner, to determine the spatial coordinates of the surface points of the outer surface 42 of the object 40 by triangulation and generate the 3D model of the object 40. In such an embodiment, the projectors 20 each project a particular light pattern onto the outer surface of the object 40, which is designed to facilitate the subsequent determination of the spatial position of each surface point on the outer surface 42 of the object 40 by triangulation, following a calibration of the light projectors 20 and/or cameras 30. Calibration techniques are generally well known to those skilled in the art and need not be described further herein.

As will be described in more details below, the system 10 described herein is designed and configured to minimize scanning time by allowing the light projectors 20 to operate simultaneously, even if when doing so, at least some of the multiple light projectors 20 interfere with one another and project light towards the same surface points of the outer surface 42 of the object 40 at once.

In order to do so, in an embodiment of the system 10, the light projectors 20 are controlled and the scanning data received from the cameras 30 is processed to allow identification of a specific source point of the projected light (i.e. the identification of a specific source point of a specific one of the projectors 20) from the light signal received on any surface point of the object 40 (i.e. even if the light signal captured by one or more cameras 30 relative to surface points of the outer surface of an object is the combination of light signals projected from more than one of the projectors 20). In other words, the light projectors 20 are controlled and the scanning data received from the cameras 30 is processed specifically to allow scanning using multiple projectors 20 at the same time, in such a way that the interference between the multiple projectors 20 does not prevent the triangulation process allowing identification of the spatial coordinates of the surface points located on the outer surface 42 of the object 40.

In more details, in an embodiment, the system 10 uses multiplexing/demultiplexing, where the light projected by each one of the projectors 20 is modulated to ensure that the light signal reflected on each one of the surface points and captured by the cameras 30 can be processed to identify the constituent light signals of each one of the multiple projectors 20. Hence, distinct light signals are emitted by each specific source point (each source point of each projector 20 emits a unique and distinctive light signal), and each multiplexed light signal resulting from the combination of light signals, which will naturally occur for multiple projectors (or source points thereof) projecting towards a same surface point of the outer surface 42 of the object 40, to define the resulting light signal reflected on the corresponding surface points of the outer surface of the object 40, can be subsequently individually identified by demultiplexing of the received light signal for each surface points of the outer surface of the object 40. Such multiplexing/demultiplexing process therefore allows efficient and simultaneous transmission over a shared spatial channel for multiple projectors 20 to share the same spatial channel, without interfering with each other's.

One skilled in the art will readily understand that theoretically, multiple distinct multiplexing techniques could be used, such as, for example and without being limitative, time-division multiplexing (TDM), frequency-division multiplexing (FDM), wavelength-division multiplexing (WDM), phase-encoded multiplexing (PEM), code-division multiplexing (CDM), or the like, and/or combinations thereof. However, it will be understood that operative constraints of the multiple projectors 20 and/or cameras 30 of the present system 10, related for example and without being limitative to saturation of the spatial channel, the point-spread function of both the projectors 20 and the cameras 30, the signal to noise ratio (SNR), the quantification, the possible inter-reflections and/or the bandwidth can affect the performance of a multiplexing/demultiplexing scheme, coloring of the surface point of the object. Hence, specific multiplexing/demultiplexing techniques will provide better results when used in a scanning system 10 as described above, using multiple fixed cameras 30 and multiple fixed projectors 20.

To that effect, a specific multiplexing/demultiplexing scheme based on frequency-division multiplexing (FDM) and implemented by the system 10, which maximizes the performance of the system 10 and/or minimizes scanning time, and a system implementing the multiplexing/demultiplexing scheme based on frequency-division multiplexing (FDM), will be described in more details below.

In an embodiment, a specific projector signal frequency is determined and associated to each one of the multiple projectors 20. The specific signal frequencies being associated to each one of the multiple projectors 20 can be determined based on the combination of the range of frequencies available given the desired operating time of the system 10 for performing the 3D scanning of an object 40 and the frame rate of the projectors 20. For example and without being limitative, in an embodiment where the desired operating time of the system 10 for performing the 3D scanning of the outer surface 42 of an object 40 is 31 seconds and the frame rate of the projectors 20 is 1 FPS, a range of 15 frequencies are available. This arises because the mathematical properties of the discrete Fourier transform dictate that there are 15 independent usable frequencies (excluding the DC component) in a discrete real signal of length 31.

One skilled in the art will understand that, in an embodiment, only subsets of the projectors 20 having interfering field of views (i.e. multiple projectors 20 which are positioned such that they can project overlapping light signals on the outer surface 42 of an object 40 placed in the scanning section 18 of the system 10 when projecting simultaneously) need to be considered and assigned different signal frequencies, non-overlapping projectors 20 being able to operate simultaneously without interfering with one another and therefore being operable similarly to conventional systems. In such alternative embodiments, the number of projectors 20 of the system 10 requiring a specific signal frequency can therefore be equated to the number of projectors 20 of the largest subset of projectors 20 having interfering field of views. Hence, it will be understood that, in an embodiment, the range of defined frequencies can be lower than the total number of projectors 20 of the system 10, as long as that the range is higher than the number of projectors 20 of the largest subset of projectors 20 having interfering field of views. In the course of the description below, reference to the multiple projectors 20 of the system can therefore be understood to also include reference to the projectors 20 of a subset of the multiple projectors 20, which have interfering field of views, with the system 10 being configured to operate similar multiplexing/demultiplexing scenario for each one of the subsets of the multiple projectors 20 having interfering field of views.

Therefore, in operation, the computing device 12 is configured to control the projectors 20 such that each one of the projectors 20 projects a grid of source light signals on the outer surface 42 of the object 40, with each source signal of the grid of source light signals being associated to a corresponding source point of the corresponding one of the multiple projectors 20 and having a carrying frequency associated to the corresponding projector 20. In an embodiment, each grid of source light signals is defined by a series of projected images, where the intensity of the light emitted by each source point of the corresponding one of the projectors 20 in each one of the images is varied to form the signal with the carrying frequency associated to the corresponding one of the multiple projectors 20. The successive grids of light signals define the overall light signals received on each surface point of the outer surface of the object 40 and form the specific light pattern projected on the outer surface 42 of the object 40.

During projection by the projectors 20 of their respective grids of source light signals, the cameras 30 capture images defining a grid of corresponding light intensities on the outer surface 42 of the object 40 varying over time, thereby defining a received light signal for each surface point of the outer surface 42 of the object 40. In view of the above, it is understood that the received light signal of each surface point of the outer surface 42 of the object 40 can include the source light signal of a source point of one of the multiple projectors 20 or the combination of source light signals of a plurality of source points of multiple projectors 20 overlapping over the corresponding section of the outer surface of the object 40.

The computing device 12 is configured to receive the scanning data from the cameras 30 corresponding to the received light signals for each surface point of the outer surface of the object 40 and to perform signal processing on each received light signal in order to demultiplex the received light signals and isolate therefrom constituent source light signals having a carrying frequency corresponding to one of the predefined specific projector signal frequency associated to one of the projectors 20. For example and without being limitative, in an embodiment, the computing device 12 is configured to perform a frequency domain analysis using a Fourier transform algorithm to demultiplex each one of the received light signals and identify the corresponding constituent source light signals associated to each one of the projectors present in the received light signals being analyzed.

In view of the above, the system 10 can therefore identify each source light signal projected on each surface point of the outer surface 42 of the object 40, and determine from the associated source light signal the source of the projected light (i.e. the specific projector from the multiple projectors 20 which projected light towards the corresponding surface point of the outer surface 42 of the object 40), even when multiple projectors 20 overlapped and projected light towards a same surface point of the outer surface 42 of the object 40.

In order to allow the subsequent identification of the specific source point of the corresponding one of the light projectors 20 from the corresponding source light signal, in an embodiment, the computing device 12 is configured to control the projectors 20 such that each source light signal of the grid of source light signals projected by the corresponding one of the projectors 20 has a specific phase indicative of the corresponding source point of the corresponding one of the projectors 20. Hence, each grid of source light signals projected by a corresponding one of the projectors 20 of the system 10 includes distinct source light signals each having a unique combination of carrying frequency and phase. In practice, in order to allow identification of each source point of a corresponding one of the light projectors 20 having a high definition (i.e. a high number of source points) the computing device 12 can be configured to control the projectors 20 such that multiple successive projections are performed by the light projectors 20 (i.e. multiple grids of source light signals are emitted by each one of the projectors 20), for example with a first projection where the phase is indicative of the column of the source point of the corresponding one of the projectors 20 and a second projection where the phase is indicative of the line of the source point of the corresponding one of the projectors 20.

In view of the above, once the computing device 12 has identified each source light signal projected on each surface point of the outer surface 42 of the object 40 from the scanning data and determined from the frequency of the associated source light signal the specific projector from the multiple projectors 20 which projected light towards the corresponding surface point of the outer surface 42 of the object 40, the computing device 12 can further identify each specific source point of the corresponding one of the light projectors 20 using the phase of the associated source light signal.

Finally, using the combination of the data relative to a position of the specific source point of the specific one of the multiple projectors 20 having projected the source light signal onto a corresponding surface point of the outer surface of the object 40 and the position of the specific one of the multiple cameras 30 having captured the received light signal for the corresponding surface point, the computing device 12 can determine the spatial coordinates of each one of the surface points located on the outer surface 42 of the object 40 by triangulation. In an embodiment, the computing device 12 can further generate the 3D model representing the outer surface 42 of the scanned object 40, using the calculated spatial coordinates of the surface points.

The above-described system 10 can operate to scan objects 40 having an unknown geometry, using the multiple fixed projectors 20 (with certain projectors 20 having overlapping fields of views) and multiple fixed cameras 30 operating simultaneously. Indeed, the above-described system 10 can operate without knowing in advance which sections of the outer surface of the object will be subjected to overlap of the source light signals of multiple projectors 20 using the above-described multiplexing/demultiplexing scheme, which can subsequently determine the specific source points of each source light signals projected on a surface point of an outer surface 42 of an object 40, even in case of source light signal overlap.

However, in some instances, at least a portion of the geometry of the object 40 to be scanned and the position of the object 40 to be scanned inside the inspection section 18 of the system 10 is known before the scan of the object 40 is performed. For example and without being limitative, this can occur through a previous scan of at least a section of the object 40 and a specific positioning of the object inside the inspection section 18 of the system 10, a previous scan of at least a section of an object presumed to be similar to the scanned object 40 and a specific positioning of the object presumed to be similar to the scanned object 40 inside the inspection section 18, through a simulation performed based on the position of the projectors 20 and the geometry and position of the object 40, etc.

In such cases, the system 10 can be configured to limit the overlap of projectors 20 having overlapping fields of views by generating operative masks for the projectors 20 having overlapping fields of views. Such operative masks would prevent a subset of the overlapping projectors 20, from beaming on specific surface points of the outer surface 42 of the object 40, such that overlapping is minimized. One skilled in the art will understand that the subset of the overlapping projectors 20 prevented from beaming on the specific surface points of the outer surface 42 of the object 40, can include a single projector from a group of overlapping projectors 20, two projectors from a group of overlapping projectors 20, three projectors from a group of overlapping projectors 20, etc., with the amount of projectors 20 in the subset of projectors 20 being smaller than the total amount of overlapping projectors. Such limitation of the overlap of source light signals from multiple projectors 20 can be advantageous given that having more overlapping projectors 20 requires a larger bandwidth, which in turn may require taking more samples, thus scanning for a longer period of time, to be able to demultiplex the received light signal formed by a combination of the source light signals of many projectors 20. Moreover, the saturation of the cameras 30 is of particular concern as it is directly hindered by the superposition of source light signals from many projectors 20 and can lead to received source light signals of lesser quality. Hence, when possible, it is advantageous to minimize the number of projectors 20 projecting overlapping source light signals towards sections of the outer surface 42 of the object 40.

In an embodiment the computing device 12 can be configured to determine outer surface sections of the outer surface 42 of the object 40 (or portions thereof) to be scanned, where projectors 20 will project overlapping source light signals towards surface points of the outer surface 42 of the object 40, if the multiple projectors 20 of the system 10 operate simultaneously. For example and without being limitative, this can be performed through a simulation performed by the computing device 12 based on the position of the projectors 20 (and their respective field of views) and the geometry of the outer surface 42 and position of the object 40.

In an alternative embodiment, the data relative to the outer surface sections of the outer surface 42 of the object 40 where projectors 20 will project overlapping source light signals towards surface points of the outer surface 42 of the object 40 can be previously generated and received by the system 10. For instance, the data relative to the outer surface sections could have been previously generated through scanning of the object 40 using a system having a similar configuration of projectors 20 and cameras 30, but where each one of the multiple projectors 20 beams light one at a time (i.e. where the projectors operate sequentially).

In an embodiment, the computing device 12 is further configured to generate the operative masks for the projectors 20 identified as projecting overlapping source light signals towards surface points of the outer surface of the object 40 in the outer surface sections and apply the generated operative masks to at least one of the projectors 20 identified as projecting overlapping source light signals towards surface points of the outer surface of the object 40 in the outer surface sections. In an embodiment, this is performed for every identified outer surface section of the outer surface of the object 40 where projectors 20 will project overlapping source light signals towards surface points of the outer surface 42 of the object 40, by determining which subset of the multiple projectors 20 identified as having source points projecting overlapping source light signals towards surface points of the outer surface of the object 40 in each specific outer surface section is most likely to provide the best light signal at the outer surface section. For example and without being limitative, this can be determined by evaluating various criteria associated to each one of the associated projectors 20, such as, the projector angle to the specific surface points, its point density, the presence of a specular highlight, the measured contrasts, etc. Following the evaluation, a score can be given to each one of the associated projectors 20, with the subset of projectors 20 having the best score being retained for projecting the source light signal towards the corresponding surface points of the section of the outer surface 42 of the object 40.

The operative masks being generated therefore allows the source points of the subset of projectors 20 having the higher score for the corresponding outer surface section of the outer surface 42 of the object 40 to project the source light signal during scanning of the object 40, while the source points of the other projectors 20 identified as having source points projecting overlapping source light signals towards surface points of the outer surface of the object 40 in the outer surface section are masked and do not project any source light signal directed towards the corresponding outer surface section during scanning of the object 40.

One skilled in the art will understand that, in operation, generated operative masks will likely not be completely effective to prevent overlapping of source light signals towards surface points of the outer surface of the object 40 as the exact geometry of the object 40 will likely not be known. Indeed, one skilled in the art will understand that the very purpose of performing a scan of the object 40 using the system 10 is to determine (or verify) its geometry, such that the objects 40 being scanned will often deviate from the known geometry, thereby causing overlapping of source light signals towards surface points of the outer surface 42 of the object 40 in certain sections, even in the presence of operative masks. Moreover, in order to avoid missing sections of the object 40 during a scan because one of the generated operative mask results in no source light signal being projected on some surface points of the outer surface of the object 40 deviating from the known geometry of the object 40 used for generating the operative masks, in an embodiment, operative masks can be avoided or limited in peripheral portions of the identified outer surface sections where projectors 20 are expected to project overlapping source light signals towards surface points of the outer surface 42 of the object 40, for example.

Therefore, it will be understood that the generated operative masks can be used as a tool to minimize the number of projectors 20 projecting overlapping source light signals towards the outer surface 42 of at least sections of known geometry of the object 40 scanned, while using the above described multiplexing/demultiplexing scheme to allow the system 10 to still tolerate overlap of source light signals projected on surface points of sections of the outer surface of the object 40 and perform the scan of these sections.

In practice, it has also been noted that in cases where there is a significant imbalance between intensities of overlapping source light signals projected on at least one surface point of the outer surface 42 of the object 40 by at least two projectors 20 projecting source light signals with different noise level towards the outer surface 42 of the object 40 being scanned, this can cause issue when demultiplexing the multiplexed received light signal for the surface points in which there is light signal overlap. Indeed, if one of the source light signals is significantly stronger than the other, the stronger signal can induce crosstalk into the weaker signal, which can make it difficult to accurately recover the constituent light signal corresponding to the weaker original source light signal by demultiplexing.

Imbalance between the intensity of the source light signal projected on surface points of the outer surface 42 of the object 40 by at least two projectors 20 projecting source light signals towards the outer surface 42 of the object 40 being scanned can also result in light bleed issue where the source light signal of greater intensity generates noise in the received light signals of adjacent surface points, which also complexifies the demultiplexing stage of the above-described multiplexing/demultiplexing scheme.

For example and without being limitative, imbalance between the intensity of the source light signals projected by the at least two projectors 20 can stem from different positioning of the projectors 20 relative to a surface point of the outer surface 42 of the object 40 resulting in a different reflective property of the surface point of the outer surface 42 of the object 40, different projectors having different wear levels (i.e. a projector being newer that another projector), etc.

Similarly to the above-described minimization of the overlap of projectors 20 having overlapping fields of views by generating and applying operative masks for the projectors 20 having overlapping fields of views, in an embodiment, the system 10 can be configured to limit the intensity imbalance of at least two projectors 20 projecting source light signals having intensity which differ enough to create crosstalk and/or light bleed by generating and applying intensity masks for the projectors 20 projecting source light signals having the different intensities. For example and without being limitative, this can apply to projectors 20 projecting source light signals having an intensity imbalance sufficient to result in phase measurement corruption that diminishes the accuracy below a desired level of precision, the desired level of precision being dependent on the targeted application of the system (i.e. the precision required for the specific industrial application for which the system is used).

The generated intensity masks operate to adjust the intensity of the source light signal of a subset of the projectors 20 beaming on specific surface points of the outer surface 42 of the object 40 (i.e. increase or lower), such that the intensity of the source signals projected by the at least two projectors 20 is balanced, to avoid or at least minimize crosstalk and/or light bleed. Once again, the subset of the projectors 20 having the intensity of the light signal for specific surface points of the outer surface 42 of the object 40 adjusted, can include a single projector from a group of projectors 20 projecting towards the surface points of the outer surface 42 of the object 40, two projectors from a group of projectors 20 projecting towards the surface points of the outer surface 42 of the object 40, three projectors from a group of projectors 20 projecting towards the surface points of the outer surface 42 of the object 40, etc.

For example and without being limitative, in an embodiment, the data relative to intensity imbalance of the light source signals projected on surface points of the outer surface 42 of the object 40 in sections of the outer surface 42 of the object 40 (or portions thereof) to be scanned can be previously generated and received by the system 10. For instance, the data relative to the intensity imbalance could have been previously generated through scanning of a similar object 40 using the system 10, with the intensity of the constituent signal of the source points of the projectors 20 (corresponding to the source light signals of the source points of the projectors being obtained based on the received light signals of surface points of the outer surface of the object. For example and without being limitative, the data relative to the intensity imbalance could have been previously generated based on constituent signal obtained for source points of the projectors, when performing demultiplexing of the received light signals.

As mentioned above, the saturation of the cameras 30 is of particular concern as it is directly hindered by the superposition of source light signals from many projectors 20 and can lead to received source light signals of lesser quality. Hence, balancing of the intensity of the projectors can also be advantageous to help in reducing saturation by the overlapping source light signals projected towards sections of the outer surface 42 of the object 40.

The system 10 having been described in detail above, the method for performing multi-projector 3D scanning will be described in more details below.

In an embodiment, the method includes the step 110 of controlling multiple fixed projectors of a multi-projector scanning system using a computing device, for each one of the projectors to project a grid of source light signals on the outer surface of an object to be scanned, with each source signal of the grid of source light signals being associated to a corresponding source point of the corresponding one of the multiple projectors and having a unique signal characteristics associated to the corresponding projector allowing a subsequent demultiplexing of each received light signals in which the source light signals of at least two projectors projecting source light signals overlapping on surface points of the outer surface of the object are combined naturally, thereby creating a multiplexed signal.

In an embodiment, this step includes the sub-step of determining a signal frequency associated to each one of the multiple fixed projectors and controlling the projector for each source signal of the grid of source light signals having the carrying frequency associated to the corresponding projector. In an embodiment this step also includes controlling each one of the projectors for each source light signals of the grid of source light signals thereof to have a phase associated to the specific source point of the corresponding one of the projectors. For example and without being limitative, in a first projection the phase is indicative of the column of the source point of the corresponding one of the projectors and in a second projection the phase is indicative of the line of the source point of the corresponding one of the projectors.

The method includes the further step 112 of projecting the grid of source light signals from each one of the multiple projectors simultaneously on the outer surface of the object to be scanned.

The method also includes the step 114 of capturing images defining a grid of corresponding light intensities on the outer surface of the object by the multiple fixed cameras, with the light intensities of successive images varying over time defining a received light signal for each surface point of the outer surface of the object.

The method further includes the step 116 of performing signal processing on each received light signal, by the computing device, in order to demultiplex the received light signals and isolate therefrom constituent source light signals having the unique signal characteristic associated to a corresponding one of the projectors. In an embodiment, this step includes performing signal processing on each received light signal, by the computing device, in order to decode the received light signals and isolate therefrom constituent source light signals having the carrying frequency corresponding to one of the predefined specific projector signal frequency associated to one of the projectors.

The method further includes the step 118 of identifying, by the computing device, each source light signal projected on each surface point of the outer surface of the object and determine from the associated source light signal the corresponding projector and the corresponding source point thereof.

The method also includes the step 120 of determining the spatial coordinates of each one of the surface points located on the outer surface of the object by triangulation, using the combination of the data relative to the specific source point of the specific one of the multiple projectors having projected the source light signal onto a corresponding surface point of the outer surface of the object and the specific one of the multiple cameras having captured the received light signal for the corresponding surface point.

In an embodiment, prior to the step of projecting the grid of source light signals from each one of the multiple projectors simultaneously on the outer surface of the object, the method can also include the steps of identify projectors projecting overlapping source light signals towards specific surface points of the outer surface of at least one outer surface section of an object having a known geometry and generating and applying operative masks for the projectors identified as projecting the overlapping source light signals towards the surface points of the outer surface of the object in the corresponding outer surface section, for masking the source points of each one of the projectors identified as having source points projecting overlapping source light signals towards surface points of the outer surface of the object 40 in the corresponding outer surface section, except for a subset of the projectors being identified as being most likely to provide the best data at the corresponding outer surface section. In other words, the method includes generating and applying operative masks for the identified projectors in order to limit the number of projectors projecting source light signals towards the specific surface points of the corresponding outer surface section.

In an embodiment the method include the substep of determining the outer surface sections of the outer surface of the object where projectors will project overlapping source light signals towards surface points of the outer surface of the object when operating simultaneously. In an embodiment, the method can include generating and applying operative masks for every identified outer surface section of the outer surface of the object where projectors will project overlapping source light signals towards surface points of the outer surface of the object when operating simultaneously.

The method can also include the substep of determining which subset of the multiple projectors identified as having source points projecting overlapping source light signals towards surface points of the outer surface of the object in each specific outer surface section is most likely to provide the best data, for each identified outer surface section of the outer surface of the object and masking the other projectors for the projectors other than those of the subset of projectors identified as most likely to provide the best light signal at the outer surface section not to project any source light signal directed towards the outer surface section during scanning of the object.

In an embodiment the method can also include, prior to the step of projecting the grid of source light signals from each one of the multiple projectors simultaneously on the outer surface of the object, the steps of identifying projectors projecting source light signals towards specific surface points of the outer surface of at least a section of an object having intensity imbalance sufficient to create crosstalk and/or light bleed. For example and without being limitative, this can apply to projectors projecting source light signals having an intensity imbalance sufficient to result in phase measurement corruption that diminishes the accuracy below a desired level of precision, the desired level of precision being dependent on the targeted application of the system (i.e. the precision required for the specific industrial application for which the system is used).

The method includes the further step of generating and applying intensity masks for the projectors identified as projecting source light signals towards specific surface points of the outer surface of at least a section of an object having intensity imbalance sufficient to create the crosstalk and/or light bleed, to balance the intensity of the source light signal of a subset of the projectors beaming on specific surface points of the outer surface of the object (i.e. increase or lower), such that the intensity of source light signals projected by the at least two projectors is balanced, to avoid or at least minimize the crosstalk and/or light bleed.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

What is claimed is:

1. A system for performing 3D scanning of an object having an outer surface defined by surface points, the system comprising:
multiple fixed projectors each projecting a grid of source light signals on the outer surface of the object, with at least two of the projectors projecting source light signals overlapping on surface points of the outer surface of the object when the projectors project the source light signals simultaneously;
multiple fixed cameras capturing images defining a grid of corresponding light intensities on the outer surface of the object, with the grid of light intensities of successive images varying over time defining a received light signal for each surface point of the outer surface of the object; and
a computing device in data communication with the multiple fixed projectors and the multiple fixed cameras, the computing device being configured to control the multiple fixed projectors such that each source signal of the grid of source light signals projected therefrom is associated to a corresponding source point of a corresponding one of the projectors and has a unique signal characteristics associated to the corresponding one of the projectors allowing a subsequent demultiplexing of received light signals for surface points of the outer surface of the object where the source light signals of the at least two of the projectors projecting source light signals overlapping on surface points of the outer surface of the object are combined, and the computing device being further configured to collect received light signals for each surface point of the outer surface of the object and performing signal processing on the received light signals in order to demultiplex the received light signals and isolate therefrom constituent source light signals having the unique signal characteristic associated to the corresponding one of the projectors.

2. The system of claim 1, wherein the computing device is configured to control the projectors such that each one of the projectors projects the grid of source light signals, with each source light signals thereof having a specific carrying frequency associated to the corresponding one of the multiple fixed projectors and being unique to the corresponding one of the projectors.

3. The system of claim 1, wherein the computing device is configured to control the projectors such that each one of the projectors projects the grid of source light signals, with each source light signals thereof having a phase associated to the specific source point of the corresponding one of the projectors.

4. The system of claim 3, wherein, in a first projection the phase is indicative of the column of the source point of the corresponding one of the projectors and in a second projection the phase is indicative of the line of the source point of the corresponding one of the projectors.

5. The system of claim 1, wherein the computing device is further configured to determine from each one of the constituent source light signals the corresponding projector and the corresponding source point thereof.

6. The system of claim 5, wherein the computing device is further configured to determine the spatial coordinates of each surface points by triangulation, using constituent source light signals, the position of the source points of each corresponding one of the projectors and the position of the cameras.

7. The system of claim 1, wherein the object has a known geometry and wherein, prior to scanning, the computing device is configured to identify projectors projecting overlapping source light signals towards specific surface points of the outer surface of at least one outer surface section of the object having the known geometry and to generate and apply operative masks for the identified projectors in order to limit the number of projectors projecting source light signals towards the specific surface points of the outer surface section.

8. The system of claim 7, wherein the computing device is configured to generate and apply operative masks for every identified outer surface section of the outer surface of the object where projectors will project overlapping source light signals towards surface points of the outer surface of the object when projecting source light signals simultaneously.

9. The system of claims 8, wherein the computing device is configured to generate the operative masks by determining which subset of the projectors identified as having source points projecting overlapping source light signals towards surface points of the outer surface of the object in each one of the at least one outer surface section is most likely to provide the best light signal at the outer surface section and masking the other projectors for the projectors other than those of the subset of projectors identified as most likely to provide the best light signal at the outer surface section not to project any source light signal directed towards outer surface section during scanning of the object.

10. The system of claim 1, wherein, prior to scanning, the computing device is configured to identify projectors projecting source light signals towards surface points of the outer surface of at least one section of the object having an intensity imbalance sufficient to create crosstalk and/or light bleed and to generate and apply intensity masks for the identified projectors in order to balance the intensity of the source light signals.

11. A method for performing multi-projector 3D scanning, the method comprising:
controlling multiple fixed projectors of a multi-projector scanning system by a computing device for each one of the projectors to project a grid of source light signals towards the outer surface of an object to be scanned, with each source signal of the grid of source light signals being associated to a corresponding source point of the corresponding one of the multiple projectors and having a unique signal characteristics associated to the corresponding projector allowing signal demultiplexing of each received light signals in which the source light signals of at least two projectors projecting source light signals overlapping on surface points of the outer surface of the object are combined;
projecting the grid of source light signals from each one of the multiple projectors simultaneously on the outer surface of the object to be scanned;
capturing images defining a grid of corresponding light intensities on the outer surface of the object using cameras, with the light intensities of successive image varying over time defining the received light signal for each surface point of the outer surface of the object;
performing signal processing on each received light signal by the computing device in order to demultiplex the received light signals and isolate therefrom constituent source light signals having the unique signal characteristic associated to a corresponding one of the projectors and determine from the associated source light signal the corresponding projector and the corresponding source point thereof; and
determining by the computing device the spatial coordinates of each surface points by triangulation.

12. The method of claim 11, further comprising determining, by the computing device, a signal frequency associated to each one of the multiple fixed projectors and controlling each one of the projectors by the computing device, for each source signal of the grid of source light signals thereof to have a carrying frequency corresponding to the signal frequency associated to the corresponding one of the projectors.

13. The method of claim 11, further comprising controlling each one of the projectors by the computing device for each source light signals of the grid of source light signals thereof to have a phase associated to the specific source point of the corresponding one of the projectors.

14. The method of claim 13, wherein in a first projection the phase is indicative of the column of the source point of the corresponding one of the projectors and in a second projection the phase is indicative of the line of the source point of the corresponding one of the projectors.

15. The method of claim 11, wherein the object has a known geometry and wherein the method further comprises:
prior to the step of projecting the grid of source light signals from each one of the multiple projectors simultaneously on the outer surface of the object, identifying, by the computing device, projectors projecting overlapping source light signals towards specific surface points of the outer surface of at least one outer surface section of the object having the known geometry; and
generating and applying operative masks for the identified projectors in order to limit the number of projectors projecting source light signals towards the specific surface points of the outer surface section.

16. The method of claim 15, comprising generating and applying operative masks for every identified outer surface section of the outer surface of the object where projectors will project overlapping source light signals towards surface points of the outer surface of the object when projecting source light signals simultaneously.

17. The method of claim 16, wherein the step of generating and applying operative masks includes determining, by the computing device, which subset of the projectors identified as having source points projecting overlapping source light signals towards surface points of the outer surface of the object in each one of the at least one outer surface section is most likely to provide the best light signal at the outer surface section and masking the other projectors for the projectors other than those of the subset of projectors identified as most likely to provide the best light signal at the outer surface section not to project any source light signal directed towards the outer surface section during scanning of the object.

18. The method of claim 11, further comprising:
prior to the step of projecting the grid of source light signals from each one of the multiple projectors simultaneously on the outer surface of the object, identifying projectors projecting source light signals towards surface points of the outer surface of at least one section of the object having an intensity imbalance sufficient to create crosstalk and/or light bleed; and
generating and applying intensity masks for the identified projectors in order to balance the intensity of the source light signals.

19. The system of claim 2, wherein the computing device is configured to control the projectors such that each one of the projectors projects the grid of source light signals, with each source light signals thereof having a phase associated to the specific source point of the corresponding one of the projectors.

20. The method of claim 12, further comprising controlling each one of the projectors by the computing device for each source light signals of the grid of source light signals thereof to have a phase associated to the specific source point of the corresponding one of the projectors.
